(19) United States
(12) Patent Application Publication
(10) Pub. No.: US 2017/0312827 A1
(43) Pub. Date: Nov. 2, 2017

(54) Method for Producing Metal Oxide Powder

(71) Applicant: REMTECH CO., LTD., Daejeon (KR)

(72) Inventors: Jung-Ho Han, Seoul (KR); Chang-Woo Lee, Daejeon (KR); Jeong-Kun Yoo, Seoul (KR)

(21) Appl. No.: 15/517,831

(22) PCT Filed: Oct. 5, 2015
(86) PCT No.: PCT/KR2015/010516

§ 371 Date: Apr. 7, 2017

(30) Foreign Application Priority Data
Oct. 8, 2014 (KR) 10-2014-0136111

(51) Int. Cl. B22F 9/24; B01J 6/00; C01G 1/02; B01J 23/76; B01J 37/08

(52) U.S. Cl. CPC B22F 9/24; B01J 23/76; B01J 37/086; C01G 1/02; B01J 6/001; B22F 2302/25; C01P 2004/90; C01P 2006/12; B22F 2998/10

(57) ABSTRACT

The present disclosure relates to a method for producing a porous metal oxide powder, and more particularly, to a method for producing a porous metal oxide powder including obtaining metal oxide precipitate slurry from an aqueous metal salt solution dissolving a water-soluble metal salt in water; solvent exchanging the water by mixing a butanol solvent and the metal oxide precipitate slurry; and drying the solvent exchanged metal oxide under atmospheric pressure conditions.

### TECHNICAL FIELD

The present disclosure relates to a method for producing a porous metal oxide powder, and more particularly, to a method for efficiently producing a highly porous super lightweight metal oxide powder having a large specific surface area.

### BACKGROUND ART

In general, the use of highly porous metal oxides having nano-sized pores has increased as the industrial applications thereof have been broadened. Such highly porous metal oxides may be very useful in preparing catalysts or highly porous metal powder particles, and such materials may be variously used in cutting-edge materials in the field of electronics and the like due to lightweightedness thereof.

In addition, such highly porous metal oxides have highly uniform dispersibility when added to a solution, and therefore may be favorably used as an additive to glass or various polymeric materials.

Technologies for obtaining such highly porous metal oxides in the art include a process of forming a metal hydroxide after dissolving a water-soluble metal salt in water and then adjusting the pH of the solution; however, metal hydroxide produced using such a process is generally produced in a colloid form in an aqueous solution, a process which may cause serious condensation between particles while filtering and drying the metal hydroxide due to fine capillary force, and as a result, a problem in which the obtained metal oxide may have coarse particles and high density may occur.

Studies have been actively carried out in order to overcome such a problem, and for example, a technology of obtaining a highly porous and super lightweight metal oxide after solvent exchanging a metal hydroxide and drying the metal hydroxide particles under supercritical conditions has been developed.

However, there is a problem in that such a process using supercritical drying conditions requires high levels of temperature and pressure, and is therefore somewhat inefficient and costly, and accordingly, production costs increase and mass production is also difficult.

Meanwhile, alcohols such as methanol, ethanol and propanol known in the art as alcohols for use in processes requiring a solvent having infinite solubility in water in an aqueous solution, therefore, in order to exchange water and a solvent between fine metal oxide particles, the solvent is required in a minimum amount equal to tens to hundreds of times that of the amount of water required for exchange, and when a solvent exchange process is carried out several times for more effective solvent exchange, the amount of the solvent required as a solvent is equal to tens of times that of the amount of water, and the completion of solvent exchange is ambiguous, therefore, an excessive amount of alcohol as a solvent tends to be consumed. In addition, the alcohol used as a solvent needs to be reused through a distillation separation method using relatively complex facilities, and, as a result, processing costs may be further increased.

Accordingly, the production of highly porous metal oxide aerogel powder particles without the use of such supercritical conditions is expected to be of great utility in the field of porous metal oxide powder particle production.

### DISCLOSURE OF INVENTION

### Technical Problem

One aspect of the present disclosure is to provide a method for producing a highly porous and super lightweight porous metal oxide powder through an efficient process carried out under atmospheric pressure conditions.

### Solution to Problem

According to one aspect of the present disclosure, a method for producing a porous metal oxide powder includes obtaining metal oxide precipitate slurry from an aqueous metal salt solution formed by dissolving a water-soluble metal salt in water; solvent exchanging the water by mixing a butanol solvent and the metal oxide precipitate slurry; and drying the solvent exchanged metal oxide under atmospheric pressure conditions.

The operation of obtaining the metal oxide precipitate slurry is preferably carried out by adjusting a pH of the aqueous metal salt solution.

The water-soluble metal salt is preferably selected from the group consisting of Fe(NO₃)₃, Fe(OH)₃, ammonium paratungstate (APT), Na₂WO₄, Na₂Mo₄, Al(NO₃), Al(NO₃)₃, A^{l}₂(S^{O}₄)₃, Zn(NO₃)₂, Ni(NO₃)₂, Fe(NO₃)₃, Cu(NO₃)₂, CdCl₂, ZrCl₄, TiCl₄ and MgSO₄.

The butanol solvent is preferably mixed in an amount of 50 to 99% by weight based on the total weight of the butanol solvent and the metal oxide precipitate slurry.

The method for producing a porous metal oxide powder preferably further includes removing a by-product by calcination at a temperature of 150° C. to 300° C. subsequently to the operation of drying.

The method for producing a porous metal oxide powder preferably further includes removing a by-product by washing the metal oxide precipitate slurry with water subsequently to the operation of obtaining the precipitate slurry.

The operation of solvent exchanging is preferably carried out using a forced mixing method accompanying stiffing conducted at a speed of 1000 to 40000 rpm.

The operation of solvent exchanging is preferably carried out by repeating an operation of adding and mixing a new solvent with the metal oxide precipitate slurry, and then separating the obtained water-saturated butanol 2 to 6 times.

The operation of solvent exchanging is preferably carried out by reflux at a temperature of 100° C. to 130° C.

The operation of solvent exchanging may be carried out using a solvent additionally including a hydrophobizing agent.

The hydrophobizing agent is preferably selected from among hexamethyldisilane (HMDS), trimethylenemethane (TMMS), ethyltriethoxysilane (ETES) and hexamethyldisiloxane (HMDSO).

The method for producing a porous metal oxide powder preferably further includes filtering the metal hydroxide precipitate slurry before, after, or both before and after the operation of solvent exchanging.

The method for producing a porous metal oxide powder preferably further includes reproducing butanol by mixing the water-saturated butanol obtained in the operation of solvent exchanging with at least one of anhydrous calcium chloride (CaCl2), phosphorous pentoxide (P₂O₅), and anhydrite (CaSO₄), and then phase separating the water.

It should be understood that different embodiments of the disclosure, including those described under different aspects of the disclosure, may be generally applicable to all aspects of the disclosure. Any embodiment may be combined with any other embodiment unless inappropriate. All examples should be understood to be illustrative and non-limiting.

### Advantageous Effects of Invention

According to the present disclosure, a highly porous metal oxide aerogel powder can be obtained by undertaking a drying process under atmospheric pressure conditions, and therefore, the process is efficient, and as a result, an innovative production cost reduction effect can be obtained. Such a highly porous metal oxide powder obtained according to the present disclosure can be widely used in fields such as catalysts and cutting-edge electronic materials.

### BRIEF DESCRIPTION OF DRAWINGS

FIG. 1 is a schematic view illustrating a condensation phenomenon due to physical capillary force occurring when precipitate slurry obtained after filtering a metal oxide is dried.

FIG. 2 is a schematic view illustrating a condensation phenomenon of iron oxide particles due to a chemical reaction occurring when precipitate slurry obtained after filtering a metal oxide is dried.

FIG. 3 is a mutual solubility graph of butanol and water depending on a temperature.

FIG. 4 is a schematic view illustrating an illustrative reflux apparatus capable of being used in the present disclosure.

FIG. 5 is a photograph obtained as iron hydroxide is mixed with an ammonium nitrate salt in Example 1.

FIG. 6 is a photograph of an ammonium nitrate salt (NH₄NO₃), a by-product present with iron oxide in Example 1, being decomposed and removed.

FIG. 7 shows porous iron oxide being obtained in Example 4, and FIG. 7(a) to FIG. 7(c) are photographs illustrating porosity and lightweightedness of the iron oxide.

FIG. 8 is a photograph in which a water layer is formed in a butanol solution, which has not undergone layer separation, by phosphorous pentoxide (P₂O₅) in Example 6.

FIG. 9 is a photograph in which a water layer is formed in a butanol solution, which has not undergone layer separation, by anhydrous calcium chloride in Example 7.

FIG. 10 is a photograph illustrating dried aluminum hydroxide obtained in Example 8.

FIG. 11 shows lightweight aluminum hydroxide obtained in Example 11, and includes photographs illustrating that the aluminum hydroxide is very readily scattered in a container due to small specific gravity as shown in FIGS. 11(a) to 11(c).

FIG. 12 is a photograph of hydrophobic zinc hydroxide obtained in Example 16.

FIG. 13 is a photograph of hydrophobic iron hydroxide obtained in Example 22.

### BEST MODE FOR CARRYING OUT THE INVENTION

Exemplary embodiments of the present disclosure will be described below in more detail with reference to the accompanying drawings. The present disclosure may, however, be embodied in different forms and should not be construed as being limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

According to the present disclosure, a method for producing a porous metal oxide powder having high porosity, super lightweightedness and a large specific surface area through a drying process under atmospheric pressure conditions or a slightly reduced pressure instead of using a high cost supercritical process is provided. Examples of the slightly reduced pressure may include a pressure greater than or equal to 600 mmhg and less than 760 mmhg, that is, less than atmospheric pressure conditions.

More specifically, the present disclosure provides a method for producing a porous metal oxide powder including obtaining metal oxide precipitate slurry from an aqueous metal salt solution dissolving a water-soluble metal salt in water; solvent exchanging the water by mixing a butanol solvent and the metal oxide precipitate slurry; and drying the solvent exchanged metal oxide under atmospheric pressure conditions.

The metal oxide mentioned in the present disclosure specifically includes a metal hydroxide, and the atmospheric pressure mentioned in the present disclosure means a pressure of approximately 1 atm, which is the same as atmospheric pressure conditions.

The operation of obtaining the metal oxide precipitate slurry may be carried out by adjusting the pH of the aqueous metal salt solution.

For example, in the case that the pH is changed as above after the water-soluble metal salt is dissolved in water, metal oxide precipitate slurry such as a metal hydroxide is formed. The metal oxide precipitate slurry produced as above is generally formed with colloids having a size of 10⁻⁵ to 10 ⁻⁹, and has a form of porous precipitates agglomerated with such fine particles. Meanwhile, the spaces between such particles are filled with water.

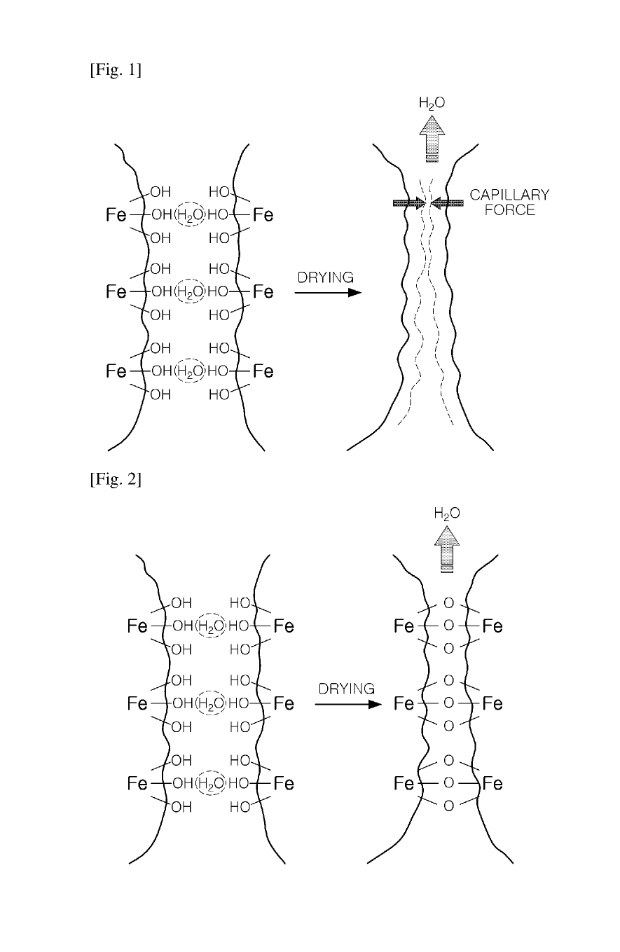

When the precipitate slurry obtained after filtering is dried, such a metal oxide experiences serious condensation as the water between the pores is dried, and as a result, the metal oxide is generally formed to solid mass particles that are hard and have high density. This is due to the fact that condensation progresses due to capillary force as the fine pores filled with an aqueous solution are contracted as in FIG. 1, or a chemical condensation reaction is progressed in the drying process due to the hydrophilic-OH on the metal hydroxide surface as in FIG. 2.

According to the present disclosure, when the water present in the porous texture of the precipitate slurry is dried by undertaking a first solvent exchange in the drying process, porosity and fine porosity that the first colloid-type precipitate slurry possesses are maintained by carrying out the drying after solvent exchanging the water with a solvent of which condensation is significantly reduced, and consequently, a metal oxide still having porosity and lightweightedness after drying, such as metal hydroxide, may be obtained.

As the butanol solvent capable of being used in the present disclosure, butanol having a level of purity closer to 100% is preferably used. Such a butanol solvent is mixed with metal oxide precipitate slurry in which precipitates are formed in an aqueous solution therefore water is mixed therein.

Herein, the butanol solvent is preferably added in an amount of 50 to 99% by weight, and more preferably in an amount of 75% by weight to 80% by weight based on the weight of the whole solution in which the butanol solvent and the metal oxide precipitate slurry are mixed. When the butanol solvent is in less than 50% by weight, the amount of the butanol solvent may be insufficient compared with the absolute quantity of the butanol solvent required to absorb and dissolve the water in the metal oxide precipitate slurry, and as a result, solvent exchange may not be completely accomplished.

A solvent exchange method using alcohol generally consumes a very large amount of an alcohol solvent thereby has an inefficient process, and economic competitiveness is also problematic, and as a result, the method has a fatal problem for commercialization. However, the present disclosure may improve such a problem by using a solvent including butanol.

According to the present disclosure, a sufficient solvent exchange reaction may be carried out by using only 4 to 5 times of butanol based on the weight of the metal oxide. Herein, when butanol is used in less than 4 times based on the weight of the metal oxide, there is a problem in that the amount of butanol may be insufficient for all the water included in the metal oxide to be substituted by butanol since the solubility of water that butanol is capable of containing is maximum 18 to 21% by volume.

In the present disclosure, butanol having a large molecular weight and high hydrophobicity is used, and mutual solubility of butanol with water does not exceed 10 to 21% as shown in the graph in FIG. 3. In addition, the butanol physically forms layer separation with an aqueous solution phase. Meanwhile, appropriate mutual solubility between butanol and water means the hydroxyl group of the metal surface present in the aqueous solution phase and the butyl group of the butanol may be exchanged to some degree as shown in the following Formula (1). M is a metal in the following Formula (1).

M—OH+OH—C₄H₉→M—OC₄H₉+H₂O Formula (1)

In the case that the hydroxyl group of the metal surface is substituted with a butyl group as described above, physical condensation due to a capillary tube is significantly reduced when dried, and accordingly, a porous metal oxide aerogel powder may be prepared by drying under atmospheric pressure conditions without using supercritical conditions.

Meanwhile, when only an exchange aspect of a metal hydroxyl group and an alcohol group is considered, the exchange may readily occur in order of methanol, ethanol, propanol, butanol, pentanol and hexanol, however, a metal butyl group is produced when butanol is used as in the present disclosure, and accordingly, solvent recovery may be readily carried out. In other words, butanol has a big advantage in that amicable solvent recovery becomes possible since butanol has an appropriate level of hydrophilicity such as above with a metal surface hydroxyl group in an aqueous solution, and at the same time, has hydrophobicity capable of physically generating layer separation with water.

In the case that an alcohol having a higher molecular weight such as pentanol and hexanol is used instead of butanol, physical recovery of the solvent may be simple since layer separation with water is more clear during the reaction due to strong hydrophobicity, however, these solvents have a problem in that they are very expensive, and in terms of an solvent exchange, also have a difficulty in contacting with a metal oxide due to such strong hydrophobicity, therefore, in the case of a metal hydroxide, there may be a problem in progressing the solvent exchange with the hydroxyl group.

In the present disclosure, water included in the metal oxide is solvent exchanged with butanol of which capillary force is far smaller than water prior to the operation of drying as described above, and accordingly, particle condensation due to capillary force hardly occurs in the subsequent operation of drying, and therefore, a high-quality porous metal oxide powder may be obtained.

The water-soluble metal salt capable of being used in the present disclosure includes metal salts such as chlorides, sulfates and nitrates, however, using nitrate that is decomposed and volatilized at relatively low temperatures is preferable in order to more efficiently obtain a pure metal oxide in subsequent processes.

In other words, the water-soluble metal salt used as a precursor may use various metal salts such as a chloride, a nitride and a sulfide of each metal, and considering economic feasibility, a metal chloride or sulfide is preferable, and when product purity is considered important, using a metal nitride is preferable.

In the case of iron for example, a water-soluble metal salt is present in various forms such as FeCl₃, FeSO₄ and FeNO₃, however, for economic feasibility, using FeCl₃ or FeSO₄ is advantageous, while nitrate, which is readily decomposed by heat and readily separated, is more preferable for obtaining a pure final oxide product, and this also applies for other water-soluble metal salts.

More specifically, the water-soluble metal salt is preferably selected from the group consisting of Fe(NO₃)₃, Fe(OH)₃, ammonium paratungstate (APT), Na₂WO₄, Na₂Mo₄, Al(NO₃), Al(NO₃)₃, Al₂(SO₄)₃, Zn(NO₃)₂, Ni(NO₃)₂, Fe(NO₃)₃, Cu(NO₃)₂, CdCl₂, ZrCl₄, TiCl₄ and MgSO₄, however, is not particularly limited thereto, and may include metal salts including other transition metals such as Pd, Co, Mn, Mo, V, Cr and Nb, and metal elements such as Ca, Ga, In and Pb.

In the case that the water-soluble metal salt forms metal precipitate slurry by an inorganic acid including Cl, SO₄, NO₃ and the like, or an organic acid including CH₃ COO and the like, the pH is preferably adjusted to 4 to 7, and in the case that the water-soluble metal salt forms metal precipitate slurry by an alkali component including Na, K, Li, NH₄ and the like, the metal salt precipitates are preferably formed by adjusting the pH to 0 to 1.

However, in the exceptive case that components including aluminum, lead, tin, zinc and the like having amphiproticity are used, the pH is preferably adjusted to 6 to 7 for efficient precipitation since these components form metal hydroxide precipitates in pH 6 to 7.

As an acid used for adjusting the pH, an inorganic acid such as sulfuric acid, hydrochloric acid and nitric acid, or an organic acid such as acetic acid may be used, and as an alkali, sodium hydroxide, ammonium hydroxide, urea, milk of lime and the like may be used, however, those that are more readily removed in a subsequent operation of drying and the like by being decomposed by heat or volatilized are preferable in order to obtain a more pure metal oxide. Accordingly, using nitric acid, an organic acid such as acetic acid, and an alkaline organic material such as ammonium hydroxide or urea as an alkali, is preferable.

Meanwhile, in the case of tungsten for example, between Na₂WO₄ and ammonium paratungstate (APT), using APT is more preferable as a matter of process convenience for obtaining a pure material since an ammonium salt is more readily removed by heat than a sodium salt.

Even in the case that water-soluble salts such as hydrochloric acid and sulfuric acid are produced as by-products, these by-products may be removed when sufficiently washed with water.

Examples of reactions forming metal oxide precipitate slurry in an aqueous solution by adjusting the pH of an aqueous metal salt solution include the following Formula (2) to Formula (11).

Fe(NO₃)+3NH₄OH→Fe(OH)₃+3NH₄NO₃ [pH 4 or higher] Formula (2)

Al(NO₃)+3NH₄OH→Al(OH)₃+3NH₄NO₃ [pH 6] Formula (3)

5(NH₄)O.2WO₃+10HNO₃→12H₂WO₄+10NH₄NO₃ [pH1 or lower] Formula (4)

Zn(NO₃)₂+2NH₄OH→Zn(OH)₂+2NH₄NO₃ [pH 6] Formula (5)

Ni(NO₃)₂+2NH₄OH→Ni(OH)₂+2NH₄NO₃ [pH 4 or greater] Formula (6)

Cu(NO₃)₂+2NH₄OH→Cu(OH)₂+2NH₄NO₃ [pH 6] Formula (7)

CdCl₂+2NH₄OH→Cd(OH)₂+2NH₄Cl [pH 4 to 5] Formula (8)

ZrCl₂+4H₂O→Zr(OH)₄+4HCl Formula (9)

TiCl₂+2H₂O→TiO₂+4HCl Formula (10)

MgSO₄+2NaOH→Mg(OH)₂+Na₂SO₄ [pH 10 to 11] Formula (11)

In the reactions, for example, the pH of a solution is acidic when most metal salts including iron (Fe) are dissolved in water, and herein, metal hydroxide precipitates may be formed when the pH of the aqueous metal salt solution is raised.

Meanwhile, the operation of solvent exchanging may be carried out using a forced mixing method accompanying stiffing conducted at a speed of 1000 to 40000 rpm, preferably 3000 to 7000 rpm, and more preferably 2000 to 4000 rpm. When the stirring is carried out with a rate of less than 1000 rpm, the hydrophobic butanol and the hydrophilic metal oxide are not sufficiently mixed and are not in contact with each other, which causes an incomplete progress of the solvent exchange, and when the stirring is carried out with a rate of greater than 40000 rpm, energy is excessively consumed compared to the mixing effect due to the stirring, which is uneconomical. The stirring described above may be carried out simultaneously with a reflux reaction, however, the stiffing may be carried out prior to a reflux reaction and the reflux reaction is carried out with the result of stirring.

Furthermore, the operation of solvent exchanging using a forced mixing method may be carried out by repeating an operation of adding and mixing a new solvent with the metal oxide precipitate slurry, and then separating the obtained water-saturated butanol 2 to 6 times, and more preferably, such an operation is repeated 3 to 5 times. Herein, the total amount of the solvent is preferably 4 to 5 times based on the weight of the metal oxide as described above.

When the solvent exchange is repeatedly carried out dividing the amount of the solvent described above, the solvent exchange efficiency of the butanol may be maximized.

Meanwhile, the operation of solvent exchanging may be carried out by reflux at a temperature of 100° C. to 120° C., and the reflux process may be preferably applied subsequently to the forced mixing method described above.

When the reflux process is carried out at a temperature of less than 100° C., there is a problem in that the reflux reaction either does not progress or only progresses very slowly, since the temperature is lower than the boiling points of butanol and water, and when the heating temperature is excessively high, at a level greater than 120° C., the boiling rate of the solution excessively increases, and the time for solvent exchange between the water and the butanol solvent is not sufficient, and as a result, the solvent exchange reaction is incompletely progressed and particle condensation occurs during the drying.

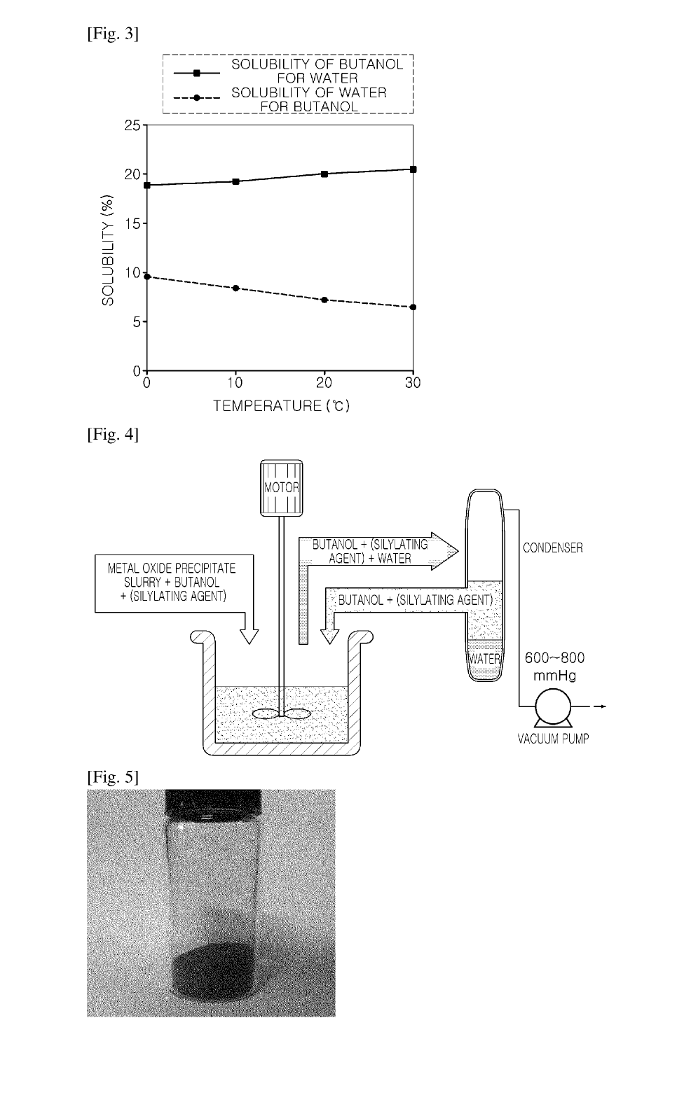

An illustrative reflux apparatus capable of being used in the reflux is shown in FIG. 4, and when the reaction is carried out for 4 to 8 hours in such a reflux apparatus, complete substitution of the butyl group is achieved even in the very fine pores.

While such an exchange reaction is progressed, water is continuously accumulated and collected in a cooler by the reaction of Formula (1), and the time when such water drops are no longer generated in the cooling unit of the reflux unit due to the layer separation of the cooled solution may be determined to be an end point of the exchange reaction when a reflux reaction apparatus is used. Accordingly, energy consumption may be reduced in the process since an end point of the exchange reaction may be clearly determined according to the present disclosure.

More specifically, the water and the solvent from reflux may be cooled to a temperature of 5° C. to 30° C., preferably cooled to a temperature of 5° C. to 20° C., and more preferably cooled to a temperature of 5° C. to 10° C. As the cooling temperature decreases, cooling condensation smoothly occurs leading to low solvent loss, however, when the temperature is less than 5° C., excessive energy tend to be consumed, and when the cooling temperature is greater than 30° C., there is a problem in that solvent loss increases since water is not condensed and the amount of the evaporated solvent is large.

Meanwhile, the present disclosure may further include an operation of removing a by-product by calcination at a temperature of 150° C. to 300° C. subsequently to the operation of drying. In the case that such an operation is additionally carried out, by-products present with the metal oxide precipitate slurry, such as ammonium nitrate, may be removed.

Meanwhile, the present disclosure may further include an operation of removing a by-product by washing the metal oxide precipitate slurry with water subsequently to the operation of obtaining the precipitate slurry, and when by-products that are not readily decomposed at high temperatures, such as sodium sulfate and sodium chloride, it is preferable to remove the by-products in advance by carrying out such an operation of washing.

Meanwhile, in the present disclosure, the operation of solvent exchanging may be carried out using a solvent additionally including a hydrophobizing agent.

In other words, the metal oxide aerogel powder obtained according to the present disclosure has its surface being substituted with a butyl group, and exhibits hydrophilicity when being mixed with water. However, in the case that a solvent additionally including a hydrophobizing agent is used in the operation of solvent exchanging as described above, a metal oxide having hydrophobicity may be produced.

Examples of the hydrophobizing agent may include a silylating agent, and more specifically, may be preferably selected from among, for example, hexamethyldisilane (HMDS), trimethylenemethane (TMMS), ethyltriethoxysilane (ETES) and hexamethyldisiloxane (HMDSO).

As described above, a preferable method for providing hydrophobicity to a metal oxide is carrying out a reflux process using a solvent additionally including a hydrophobizing agent. Using a solvent including a hydrophobizing agent such as a silylating agent in a reflux process as described above may be very economical and effective since hydrophobicity may be sufficiently obtained when a hydrophobizing agent is used only in 1 to 3% by volume based on the total volume of the butanol and the aqueous solution, and an unreacted hydrophobizing agent may be refluxed again and reused. Meanwhile, in the case that a hydrophobizing agent is directly introduced to an aqueous solution or a metal oxide in which an aqueous solution is present in large quantities, minimum 3 to 5 times or more of the hydrophobizing agent is consumed.

Particularly, most silylating agents including trimethylenemethane (TMMS), hexamethyldisiloxane (HMDSO) and the like experiences a non-reversible reaction in which the silylating agent first hydrolyzes with an acid ion present in water to produce hydroxysilane, chlorosilane and the like as shown in the reaction of the following Formula (12), and these materials are difficult to recover since they are well-dissolved in water and washed out once reacted with water. Accordingly, carrying out a reaction in a closed system such as a reflux apparatus is efficient in terms of the costs of a silylating agent.

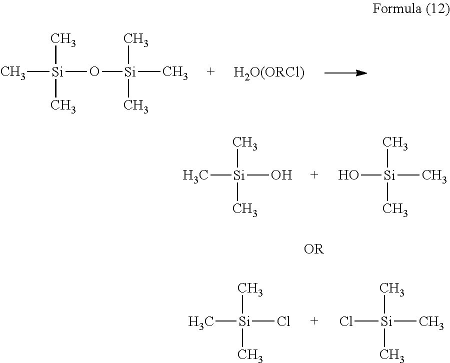

Hydroxysilane, chlorosilane and the like induced by the hydrolysis reaction from such a silylating agent exhibit hydrophobicity on the surface by being reacted with a metal surface substituted with a butyl group from the previous solvent exchange or a metal surface having a hydroxyl group as in the following Formula (13) or Formula (14).

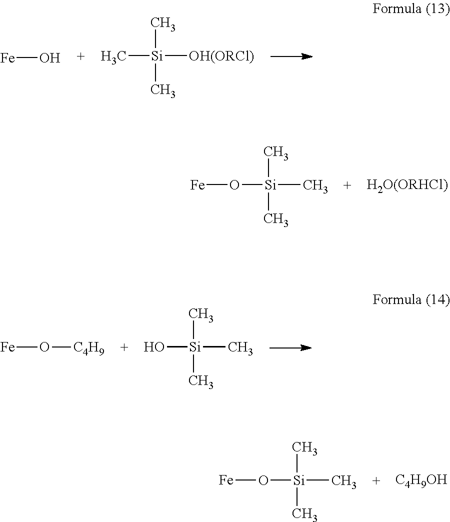

More specifically, a reaction such as the following Formula (15) or Formula (16) is undertaken in the case of trimethylenemethane.

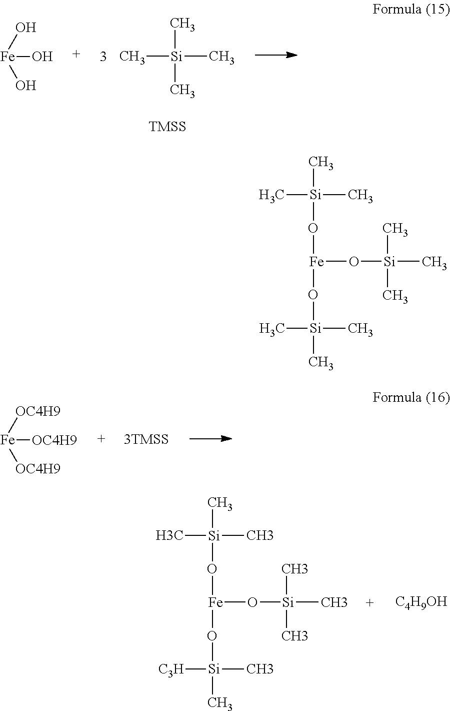

Such a process of the present disclosure may be used for almost all types of metals such as Be, Mg, Ca, Sn, Pb, Ga, Ge, In, Ti, Cd, Au, Pd, Co, Cr, Mn and Nd. However, conditions of the aqueous solution, in which hydroxymetal precipitates are produced, such as pH and impurity concentration may be somewhat different depending on the types of the metals, and for example, as described above, metal hydroxide precipitate slurry such as Fe(OH)₃, Al(OH)₃, Zn(OH)₂, Ni(OH)₂, H₂WO₄ and Cu(OH)₂ may be formed by adjusting the pH of the aqueous solution to a region capable of precipitating each metal ion component as a hydroxide after dissolving the water-soluble metal salt in water. Such a pH range may be appropriately determined with reference to equilibrium property data in an aqueous solution according to known pH-Eh for each metal.

Meanwhile, an operation of filtering the metal hydroxide precipitate slurry may be further included before, after, or both before and after the operation of solvent exchanging.

More specifically, the filtered material, which is obtained by filtering the precipitate slurry obtained after carrying out the operation of obtaining the metal oxide precipitate slurry, may be solvent exchanged with butanol. The solvent exchange may be carried out by repeatedly contacting or forced mixing the filtered metal oxide with a sufficient amount of butanol, or by a reflux process, or both of these may be carried out together to achieve the solvent exchange as described above.

When the solvent exchange reaction is complete as described above, an operation of drying the reaction product at atmospheric pressure conditions is carried out after recovering the used butanol solvent. Herein, the drying temperature is preferably higher than or equal to the boiling point of butanol, and the boiling point of butanol ranges from approximately 87° C. to 118° C. depending on the types of isomers, therefore, the drying is preferably carried out at 118° C. or higher, and more preferably at 120° C. to 300° C. When the temperature of the drying is greater than 300° C., a sintering reaction is progressed between the particles and parts of the pores may be condensed.

Furthermore, the solvent including the butanol used in the present disclosure may be reused as it is. Particularly, the butanol used in the reflux process and then regenerated may be used as it is without a problem. However, the butanol may be reused with an additional operation of regenerating the butanol by mixing the water-saturated butanol obtained in the operation of solvent exchanging with at least one of anhydrous calcium chloride (CaCl2), phosphorous pentoxide (P₂O₅), and anhydrite (CaSO₄), and then phase separating the water.

In other words, this is a method of adding a material such as anhydrous calcium chloride (CaCl2), phosphorous pentoxide (P₂O₅) and anhydrite (CaSO₄), which chemically forms a hydrate in a simple manner, in an anhydride form to a butanol solution to regenerate. Among these, inexpensive calcium chloride anhydride is particularly advantageous in terms of cost.

The amount of water dissolved in butanol is maximum 18 to 21 g in 100 g of butanol as identified in FIG. 3, and approximately 18 to 21 g of water is included in 100 g of water-saturated butanol as described above. When, for example, anhydrous calcium chloride (CaCl2) is added thereto, crystals of maximum hexahydrate (CaCl₂.H₂O) are formed, and anhydrous calcium chloride (CaCl2) reacts with water present in butanol and brings the water in butanol as the anhydrous calcium chloride is converted to a hexahydrate, and layer separation is obtained while forming an interface with the water.

In other words, 100 g of water-saturated butanol may be sufficiently separated, in theory, using approximately 20 to 25 g of anhydrous calcium chloride (CaCl2), and the resulting regenerated butanol exhibits specific gravity of 0.82 to 0.83, which is very close to the specific gravity of pure butanol.

As described above, the porous metal oxide powder obtained using the method according to the present disclosure has properties that apparent specific gravity ranges from 0.2 to 0.6, and a specific surface area ranges from 170 to 450 m²/g and preferably ranges from 200 to 420 m²/g, and exhibits a metal oxide or hydroxide aerogel form and properties having a very large specific surface area and very low specific gravity.

Moreover, according to the present disclosure, drying while maintaining the pores of cellulose or a polymer material coexisting with an aqueous solution or in an aqueous solution phase is possible, and therefore, an aerogel form of cellulose or a polymer material may be obtained.

Hereinafter, the present disclosure will be described in more detail with reference to specific examples. However, the following examples are for illustrative purposes only, and the scope of the present disclosure is not limited thereto.

### EXAMPLE

### Example 1

20 g of Fe(NO₃)₃ was dissolved in 200 ml of water, and ammonia water diluted at a ratio of 1:1 was slowly added to this aqueous solution to adjust the pH of the solution to 5 to 7. Herein, approximately 80 ml of Fe(OH)₃ precipitate slurry was obtained. The obtained precipitates were filtered, and then 600 ml of butanol was added to the filtered precipitate slurry. The result was reacted while being heated and refluxed using a reflux-type reactor illustrated in FIG. 5.

Herein, a stirrer rotating at high speed was installed in the reactor and the precipitate slurry and the butanol were reacted while being mixed. The water from reflux was separated and discharged outside, and the reaction was carried out until no more water was discharged. Then, the reaction product was taken out and dried for 4 hours at 130° C.

The iron hydroxide dried and obtained herein was obtained in a state of being mixed with an ammonium nitrate salt as shown in FIG. 5, and herein, the apparent specific gravity was 0.45, and the specific surface area was 306 m²/g.

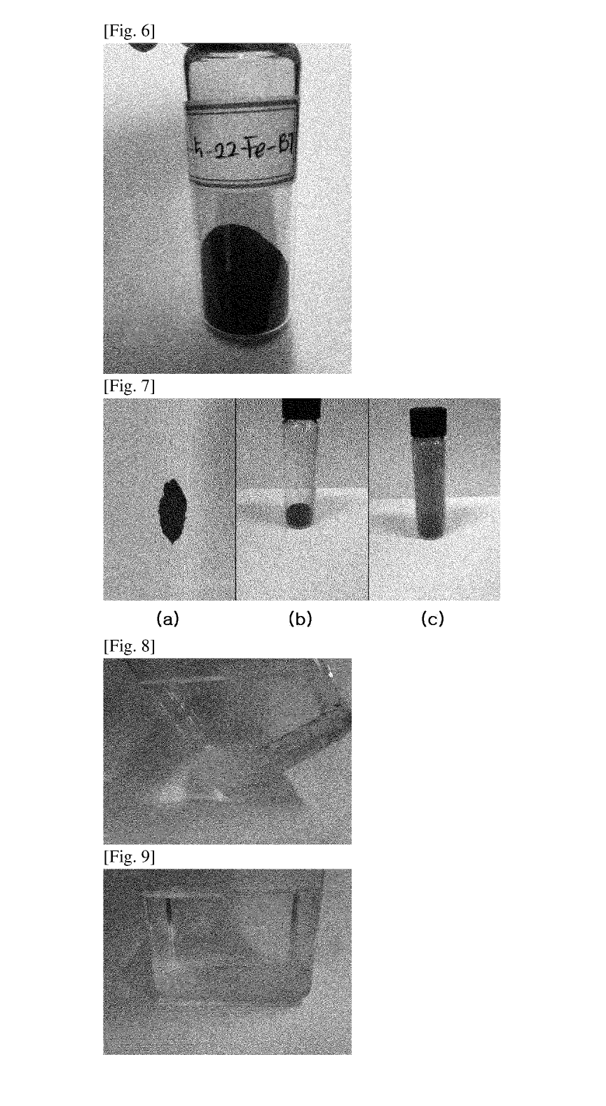

When the iron hydroxide was calcinated at a temperature of 250° C. or higher after the drying, the ammonium nitrate salt (NH₄NO₃), a by-product present together with the iron oxide, was decomposed and removed, and as a result, it was identified that the final product obtained exhibited a dark red color, a color of original iron oxide, as shown in FIG. 6.

### Example 2

40 g of Fe(NO₃)₃ was dissolved in 200 ml of water, and ammonia water diluted at a ratio of 1:1 was slowly added to this aqueous solution to adjust the pH of the solution to 5 to 7. Herein, approximately 150 ml of Fe(OH)₃ precipitate slurry was obtained. The obtained precipitates were filtered, then 2000 ml of butanol was added to the filtered precipitate slurry and mixed with the slurry at high speed. Most of the water included in the precipitate slurry was dissolved in the butanol during the mixing process, and after filtering the result, the result was dried for 3 hours or longer at 130° C. using an oven-type drying apparatus. Herein, the dried iron hydroxide exhibited apparent specific gravity of 0.59, and a specific surface area of 293 m²/g.

### Example 3

40 g of Fe(NO₃)₃ was dissolved in 200 ml of water, and ammonia water diluted at a ratio of 1:1 was slowly added to this aqueous solution to adjust the pH of the solution to 5 to 7. Herein, Fe(OH)₃ precipitates were produced. Such precipitate slurry was washed with 300 ml of water to wash out and remove an NH₄NO₃ salt, a by-product. Such washing and filtering processes were repeated approximately 5 times. The filtered precipitate slurry after removing almost all of the NH₄NO₃ salt had a volume of approximately 150 ml, and when 300 ml of butanol was added and mixed thereto at a high rate of 3000 rpm, the water component in the precipitate slurry was dissolved in the butanol solution, and the butanol solution became water-saturated butanol in which water was dissolved in saturation. Such a state showed phase separation between the water and the butanol, therefore, separation was very readily accomplished. Accordingly, after the separation, a process of adding an additional 300 ml of a new butanol solution to the precipitate slurry, mixing the result at high speed, and then separating the slurry again was repeated 5 times to uniformly disperse the slurry into the butanol solution.

Herein, complete solvent exchange may be achieved by carrying out additional filtering and forced mixing of butanol, however, faster and simpler solvent exchange may be achieved by a heating using a reflux-type solvent exchange method followed by forced mixing for approximately 5 times. For this, the precipitate slurry gone through a forced physical mixing method for 5 times was introduced to a reflux reaction apparatus illustrated in FIG. 4, and the water present in the slurry was discharged while repeatedly refluxing the precipitate slurry with heating.

When the solvent exchange process of water carried out in this Example was analyzed stepwise, it was identified that the amount of water first introduced in preparing the iron hydroxide precipitate slurry was 200 ml, and 70 ml of the water was separated in the final solvent exchange process using a method of heating under reflux, and the remaining 130 ml of the water was separated by being dissolved in the butanol using a repeated forced mixing method.

The obtained iron hydroxide obtained after the solvent exchange reaction was dried for 3 hours or longer at 130° C. The dried iron hydroxide exhibited apparent specific gravity of 0.42, and a very high specific surface area value of 413 m²/g. In this Example, no separate process for removing NH₄NO₃ was required since NH₄NO₃ was removed in the washing process previously carried out, and very porous iron oxide was prepared as shown in FIG. 7, and as identified in FIG. 7(a) to FIG. 7(c), the iron oxide exhibited properties of porous and lightweight iron oxide sufficiently to see the iron oxide rise to the top of the container like smoke and then sink even when lightly agitated.

### Example 4

Porous iron oxide was obtained using the same process as in Example 3, except that the operation of washing with water was not carried out before the operation of solvent exchanging, and calcination was carried out at a temperature of 250° C. or higher after the drying process by heating under reflux. A product identical to the product obtained in Example 3 may be obtained by removing the mixed ammonium nitrate through calcination.

Herein, the amount of water first introduced was 200 ml, and 76 ml of the water was separated in the final solvent exchange process using a method of heating under reflux, and the remaining 134 ml of the water was separated by being dissolved in the butanol using a forced mixing method.

### Example 5

The amount of the butanol used in the forced mixing method in Example 3 was 300×5=1500 ml, and 400 g of phosphorous pentoxide was introduced to the water-saturated butanol obtained as above. In the butanol solution dissolving water in saturation, the phosphorous pentoxide (P₂O₅) chemically attracted the water to form a phosphoric acid solution (2H₃PO₄).

As a result, a water layer was formed in the butanol solution previously without layer separation, as seen in the following FIG. 8, and accordingly, the butanol solution was able to be reduced to pure butanol as the water was separated from the water-saturated butanol solution. Specific gravity of the solutions was compared in order to confirm this. The butanol solution including no water at all exhibited specific gravity of 0.81, and 1500 ml of the water-saturated butanol solution in which water was saturated exhibited specific gravity of 0.91, and the specific gravity of the butanol solution in which a water layer was formed using phosphorous pentoxide and the water layer was separated therefrom was 0.83. This result confirmed that water was mostly removed and separated from the butanol dissolving water in saturation and the butanol was regenerated to a degree that almost no water was dissolved therein.

Therefore, the butanol used for removing water in the present disclosure may be reused very effectively, and accordingly, it can be seen that the efficiency of the processes according to the present disclosure was very effectively improved.

### Example 6

Water was separated from a water-saturated butanol solution and the butanol solution was reduced to pure butanol using the same process as in Example 5, except that 120 g of anhydrous calcium chloride was introduced instead of phosphorous pentoxide.

In the butanol solution dissolving water in saturation, the anhydrous calcium chloride chemically attracted the water to form CaCl₂.H₂O, and as a result, a water layer was formed in the butanol solution previously without layer separation, and was present as an aqueous solution, as seen in the following FIG. 9, therefore, the water layer was very readily separated. Specific gravity of the solutions was compared as an indirect proof that the water was separated from the water-saturated butanol solution by adding anhydrous calcium chloride, and the butanol solution was reduced to pure butanol. The butanol solution including no water at all exhibited specific gravity of 0.81, and 1500 ml of the water-saturated butanol solution in which water was saturated exhibited specific gravity of 0.88, and the specific gravity of the butanol solution in which a water layer was formed using anhydrous calcium chloride and the water layer was separated therefrom was 0.826, which was hardly different from 0.81, specific gravity of pure butanol, and as a result, it was confirmed that the water dissolved in the butanol was mostly removed.

### Example 7

30 g of Al(NO₃)₃ was dissolved in 200 ml of water, and ammonia water diluted at a ratio of 1:1 was slowly added to this aqueous solution to adjust the pH of the solution to 6 to 7. Herein, Al(OH)₃ precipitates were produced. The obtained precipitates were filtered, and then 600 ml of butanol was added to the filtered precipitate slurry. The result was reacted by reflux while heating using a reflux-type reactor. Herein, a stirrer rotating at high speed was installed in the reactor and the precipitate slurry and the butanol were reacted while being mixed.

The water and the solvent from reflux were cooled with cooling water of 15° C. to 20° C. for layer separation, and the butanol at the top was refluxed again while the water at the bottom was separated and discharged outside. The reaction was carried out until no more water is discharged, and then, the reaction product was taken out and dried for 4 hours at 130° C. The dried aluminum hydroxide product was as shown in FIG. 10, and exhibited apparent specific gravity of 0.38, and a specific surface area of 287 m²/g.

### Example 8

30 g of Al(NO₃)₃ was dissolved in 200 ml of water, and ammonia water diluted at a ratio of 1:1 was slowly added to this aqueous solution to adjust the pH of the solution to 6 to 7. Herein, Al(OH)₃ precipitates were produced. The obtained precipitates were filtered, and then 2000 ml of butanol was added to the filtered precipitate slurry. This was mixed with the precipitate slurry for 10 minutes at high speed. Most of the water included in the precipitate slurry was dissolved in the butanol during the mixing process. After filtering the result, the result was dried for 3 hours or longer at 130° C. using an oven-type drying apparatus. Herein, the dried aluminum hydroxide exhibited apparent specific gravity of 0.35, and a specific surface area of 236 m²/g.

### Example 9

30 g of Al₂(SO₄)₃ was dissolved in 200 ml of water, and the pH was adjusted to 6 to 7 using a 1 N NaOH solution. Herein, Al(OH)₃ precipitates were produced. These precipitates were washed 5 times with 200 ml of water. Herein, Na₂SO₄produced as a by-product was removed in the washing process. After filtering, 2000 ml of butanol was added to the filtered precipitate slurry. This was mixed with the slurry at high speed. After filtering the result, the result was dried for 3 hours or longer at 130° C. using an oven-type drying apparatus. Herein, the dried aluminum hydroxide exhibited apparent specific gravity of 0.35, and a specific surface area of 268 m²/g.

### Example 10

30 g of Al(NO₃)₃ was dissolved in 200 ml of water, and ammonia water diluted at a ratio of 1:1 was slowly added to this aqueous solution to adjust the pH of the solution to 6 to 7. Herein, Al(OH)₃ precipitates were produced. These precipitates were washed while being filtered with 300 ml of water to wash out and remove ammonium nitrate, a by-product, and most of the ammonium nitrate was removed by being washed out with water after repeating such a washing process 5 to 6 times.

After filtering, 300 ml of butanol was added to the filtered precipitate slurry. This was mixed at 3000 rpm using a high speed mixer. When the water and the water-saturated butanol were phase-separated, the water-saturated butanol was separated, and then an additional 300 ml of a new butanol solution was added to the precipitate slurry, the result was mixed at high speed, and then the slurry was re-separated. The slurry was uniformly dispersed into the butanol solution when this process was repeated 5 times. After that, the precipitate slurry mixture was introduced to a reaction reflux apparatus, and the result was heated under reflux to discharge the water remaining in the slurry.

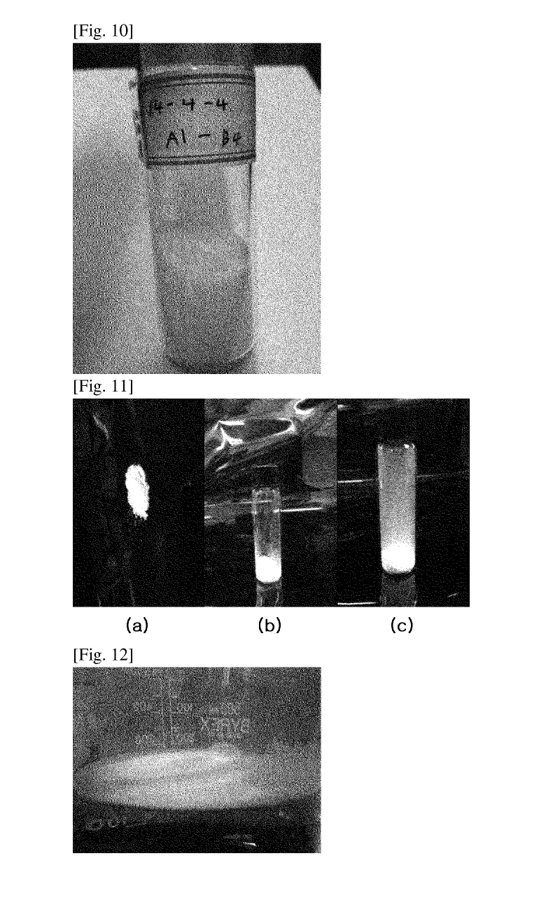

The amount of water first introduced was 200 ml, and 63 ml of the water was separated in the final solvent exchange process in which a heating under reflux method was used, and the remaining water was separated by being dissolved in the butanol using a forced mixing method. After the reaction was complete, the aluminum hydroxide was dried for 3 hours or longer at 130° C. using an oven-type drying apparatus. The dried aluminum hydroxide exhibited lightweightedness having apparent specific gravity of approximately 0.29, which was approximately 1/10 of general aluminum oxide, and exhibited a very high specific surface area with a specific surface area of 408 m²/g. In addition, it was identified that the dried aluminum hydroxide was very readily scattered in the container even when being lightly agitated due to small specific gravity, as shown in FIGS. 11(a) to 11(c).

### Example 11

20 g of ammonium paratungstate (APT) was dissolved in 200 ml of water, and nitric acid having a concentration of 68% diluted at a ratio of 1:1 was slowly added to this aqueous solution to adjust the pH of the solution to 0 to 1. As the acid, hydrochloric acid, sulfuric acid or the like may be used, however, using nitric acid or an organic acid such as acetic acid, which is readily heat decomposed later, is preferable. Herein, H₂WO₄ precipitates were produced.

These precipitates were filtered and washed 5 times with approximately 200 ml of water to obtain precipitate slurry in which most of the ammonium nitrate was washed out, and then 600 ml of butanol was added to the precipitate slurry. This was placed in a reflux-type reactor, and reacted while being heated under reflux. Herein, a high speed mixer was equipped in the reactor, and the precipitate slurry and the butanol were reacted while being mixed at 3000 rpm. The water from reflux was separated and discharged outside and the reaction was carried out until no more water was discharged. Then, the reaction product was taken out and dried for 4 hours at 140° C. Herein, the dried tungsten oxide exhibited apparent specific gravity of 0.45 and a specific surface area of 279 m²/g.

### Example 12

Dried tungsten oxide was obtained using the same process as in Example 11, except that 2000 ml of butanol was added to the precipitate slurry in which some of the ammonium nitrate was washed out after filtering and washing twice using approximately 200 ml of water, the butanol and the precipitate slurry were mixed at 3000 rpm without using the reflux reactor, and the result was dried for 3 hours or longer at 130° C. using an oven-type drying apparatus. Herein, NH₄NO₃, a by-product, produced during the reaction coexisted in the tungsten oxide, but was readily decomposed and removed when calcinated at a temperature of 250° C. or higher. The tungsten oxide obtained as above exhibited apparent specific gravity of 0.58, and a specific surface area of 198 m²/g.

### Example 13

Dried tungsten oxide was obtained using the same process as in Example 12, except that 20 g of Na₂WO₄ was dissolved in 200 ml of water, then 36% concentrated hydrochloric acid diluted at a ratio of 1:1 was slowly added to this aqueous solution to adjust the pH of the solution to 0 to 1, and H₂WO₄ precipitate slurry was obtained by washing out NaCl, a by-product, through washing and filtering the produced H₂WO₄ precipitates approximately 5 times with approximately 300 ml of water. The tungsten oxide obtained as above exhibited apparent specific gravity of 0.54, and a specific surface area of 203m²/g.

### Example 14

20 g of ammonium paratungstate was dissolved in 200 ml of water, and nitric acid having a concentration of 68% diluted at a ratio of 1:1 was slowly added to this aqueous solution to adjust the pH of the solution to 0 to 1. Herein, H₂WO₄ precipitates were produced. These were filtered and washed 5 to 6 times with approximately 300 ml of water to remove most of the ammonium nitrate. 300 ml of butanol was added to the last filtered precipitation slurry. A water-saturated butanol solution was obtained by mixing the result using a high speed mixer. After that, the water and the water-saturated butanol were phase separated, an additional 300 ml of a new butanol solution was added to the precipitate slurry, the result was mixed at high speed, and then the precipitate slurry was separated. The slurry was uniformly dispersed into the butanol solution when this process was repeated 5 times. After that, the precipitate slurry mixture was introduced to a reaction reflux apparatus, and the result was heated and refluxed to discharge the water remaining in the slurry.

In this process, the amount of water first introduced was 200 ml, and 57 ml of the water was separated in the final solvent exchange process in which a heating under reflux method was used, and the remaining water was separated by being dissolved in the butanol using a forced mixing method. After the reaction was complete, the tungsten oxide was dried at 130° C. The dried tungsten oxide exhibited apparent specific gravity of 0.42, and a specific surface area of 397 m²/g.

### Example 15

20 g of Zn(NO₃)₂ was dissolved in 200 ml of water, and ammonia water diluted at a ratio of 1:1 was slowly added to this aqueous solution to adjust the pH of the solution to 5 to 7. Herein, Zn(OH)₂ precipitates were produced. These precipitates were washed 5 times with 300 ml of water to wash out and remove a NH₄NO₃ salt, a by-product, and such a washing process and a filtering process were repeated approximately 5 times. 300 ml of butanol was added to the filtered pure-formed Zn(OH)₂ precipitate slurry in which most of the NH₄NO₃ salt was removed. When the result was mixed at 3000 rpm using a high speed mixer, the water component in the precipitate slurry was dissolved in the butanol, and the butanol became water-saturated. Such water-saturated butanol and water were phase separated, 300 ml of new butanol was added and mixed to the precipitate slurry at high speed, and the slurry was re-separated. The slurry was uniformly dispersed into the butanol by repeating such a process 5 times. After that, a heating under reflux-type solvent exchange process was carried out, and herein, the reflux reaction was carried out by adding 20 ml of TMMS, a silylating agent, and heating. As a result, the water present in the slurry was discharged, and a silylation reaction was carried out to hydrophobitize the surface while completely solvent exchanging the zinc hydroxide.

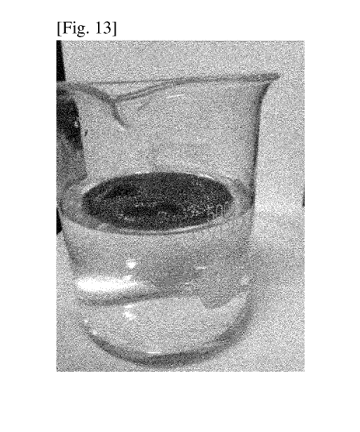

The reaction was carried out for 8 hours, and the zinc hydroxide was dried at 130° C. after the reaction. The dried zinc hydroxide exhibited very low apparent specific gravity of 0.43, and a very high specific surface area of 420 m²/g. In addition, the dried zinc hydroxide exhibited strong hydrophobicity when placed in water, as shown in FIG. 12.

### Example 16

20 g of ZnSO₄ was dissolved in 200 ml of water, and NaOH having a concentration of 2 N was slowly added to this solution to adjust the pH of the solution to 5 to 7. Herein, Zn(OH)₂ precipitates were produced. These were filtered and washed 5 times, and 600 ml of butanol was added to the last filtered precipitate slurry. A reflux reaction was carried out by placing and heating the result in a reflux-type reactor. Herein, the precipitate slurry and the butanol were reacted while being mixed at 3000 rpm using a high speed mixer. The water from reflux was separated and discharged outside and the reaction was carried out until no more water was discharged. Then, the reaction product was taken out and dried for 4 hours at 120° C. Herein, the dried zinc hydroxide product exhibited apparent specific gravity of 0.49, and a specific surface area of 259 m²/g. In this case, the produced Na₂SO₄, a by-product, is not readily dissolved even at high temperatures, therefore, needs to be removed in the washing process in order to increase the purity.

### Example 17

20 g of CdCl₂ was dissolved in 200 ml of water, and ammonia water diluted at a ratio of 1:1 was slowly added to this aqueous solution to adjust the pH of the solution to 5 to 7. Herein, Cd(OH)₂ precipitates were produced. These were washed 6 times with 200 ml of water to remove NH₄Cl, a by-product, and then 600 ml of butanol was added to the last filtered precipitate slurry. This was placed in a reflux-type reactor, and reacted while being heated under reflux. Herein, the precipitate slurry and the butanol were reacted while being mixed at 3000 rpm using a high speed mixer. The water from reflux was separated and discharged outside and the reaction was carried out until no more water was discharged. Then, the reaction product was taken out and dried for 4 hours at 120° C. Herein, dried cadmium hydroxide was obtained and the obtained cadmium hydroxide exhibited apparent specific gravity of 0.49, and a specific surface area of 194 m²g. In this case, high-purity cadmium hydroxide may be obtained by raising the temperature to 350° C. or higher and carrying out calcination in order to increase the purity of the product since a small amount of NH₄Cl capable of remaining in the product is decomposed and removed.

### Example 18

20 g of CuCl2 was dissolved in 200 ml of water, and ammonia water diluted at a ratio of 1:2 was slowly added to this aqueous solution to adjust the pH of the solution to 5 to 7. Herein, Cu(OH)₂ precipitates were produced. These were repeatedly filtered 4 to 5 times using approximately 200 ml of water, and NH₄Cl, a salt produced as a by-product, was removed, and then 600 ml of butanol was added to the filtered precipitate slurry. A reflux reaction was carried out by placing and heating the result in a reflux-type reactor. Herein, the precipitate slurry and the butanol were reacted while being mixed at 3000 rpm using a high speed mixer. The water from reflux was separated and discharged outside and the reaction was carried out until no more water was discharged. Then, the reaction product was taken out and dried for 4 hours at 120° C. Herein, the dried copper hydroxide exhibited apparent specific gravity of 0.38, and a specific surface area of 223 m²/g.

### Example 19

When 20 g of ZrCl₄ was placed in 200 ml of water, the precipitates of Zr(OH)₂, which is zirconium hydroxide, were produced. These were washed 4 times with 200 ml of water to remove HCl, a by-product, and 600 ml of butanol was added to the last filtered precipitate slurry. A reflux reaction was carried out by placing and heating the result in a reflux-type reactor. Herein, the precipitate slurry and the butanol were reacted while being mixed at 3000 rpm using a high speed mixer. The water from reflux was separated and discharged outside and the reaction was carried out until no more water was discharged. Then, the reaction product was taken out and dried for 4 hours at 120° C. Herein, a dried zirconium hydroxide product was obtained, and the obtained product exhibited apparent specific gravity of 0.56, and a specific surface area of 178 m²/g.

### Example 20

20 g of Ni(NO₃)₂ was dissolved in 200 ml of water, and ammonia water diluted at a ratio of 1:1 was slowly added to this aqueous solution to adjust the pH of the solution to 5 to 7. Herein, Ni(OH)₂ precipitates were produced. After filtering the precipitates, the result was repeatedly washed and filtered 5 times using 200 ml of water to remove ammonium nitrate, a by-product, and 600 ml of butanol was added to the last filtered precipitate slurry. A reflux reaction was carried out by placing and heating the result in a reflux-type reactor. Herein, the precipitate slurry and the butanol were reacted while being mixed at 3000 rpm using a high speed mixer. When a more or less uniform aqueous solution phase was formed during the reaction, the operation of the high speed mixer was stopped, and a reflux reaction was processed. The reaction was carried out for approximately 5 to 6 hours. When the liquid phase evaporated from inside the reactor was cooled in a cooling unit, the butanol and the water were phase separated, and the reaction was terminated when the amount of the water at the layer separation interface no longer increased. The refluxed and separated water was discharged outside. After the reaction was complete, the reaction product was dried for 4 hours or longer at 120° C. Herein, the dried nickel hydroxide product exhibited apparent specific gravity of 0.45, and a specific surface area of 304 m²/g.

### Example 21

20 g of Fe(NO₃)₃ was dissolved in 200 ml of water, and ammonia water diluted at a ratio of 1:1 was slowly added to this aqueous solution to adjust the pH of the solution to 5 to 7. Herein, the Fe(OH)₃ precipitates were washed and filtered 5 times using 300 ml of water to remove a nitric acid salt, and after filtering, a solvent mixing 10 ml of HMDSO and 10 ml of ETES to 600 ml of butanol was added to the filtered precipitate slurry. This was placed in a reflux-type reactor, and reacted while being heated under reflux. Herein, the reaction was carried out by mixing the precipitate slurry and the solvent at 3000 rpm using a high speed mixer. The water from reflux was separated and discharged outside and the reaction was carried out until no more water was discharged. Then, the reaction product was taken out and dried for 4 hours at 120° C. Herein, the dried iron hydroxide product exhibited apparent specific gravity of 0.43, and a specific surface area of 398 m²/g, and had strong hydrophobicity when placed in water, as shown in FIG. 13.

### Comparative Example 1

30 g of Al(NO₃)₃ was dissolved in 200 ml of water, and ammonia water diluted at a ratio of 1:1 was slowly added to this aqueous solution to adjust the pH of the solution to 6 to 7. Herein, Al(OH)₃ precipitates were produced. After filtering the result, 600 ml of pentanol was added to the filtered precipitate slurry. This was placed in a reflux-type reactor, and reacted while being heated under reflux. Herein, the precipitate slurry and the pentanol were reacted while being mixed at 3000 rpm using a high speed mixer. The water from reflux was separated and discharged outside and the reaction was carried out until no more water was discharged. Then, the reaction product was taken out and dried for 4 hours at 120° C. In this case, the dried aluminum hydroxide product experienced serious condensation, and exhibited apparent specific gravity of 0.32, and a specific surface area of 49 m²/g. It was identified that pentanol did not smoothly progress the solvent exchange, and metal hydroxide condensation occurred.

### Comparative Example 2

30 g of Al(NO₃)₃ was dissolved in 200 ml of water, and ammonia water diluted at a ratio of 1:1 was slowly added to this aqueous solution to adjust the pH of the solution to 6 to 7. Herein, Al(OH)₃ precipitates were produced. After filtering the precipitates, 2000 ml of ethanol was added to the filtered precipitate slurry and was mixed with the slurry for 10 minutes at high speed. During this process, the precipitate slurry was all dispersed into the ethanol. After filtering the result, the filtered result was dried for 3 hours or longer at 130° C. in a dryer. In this case, the dried aluminum hydroxide product exhibited apparent specific gravity of 1.95, and a specific surface area of 93m²/g. In this case, the ethanol may not be regenerated using anhydrous calcium chloride or phosphorous pentoxide, and a complex multi-step distillation process is required for regeneration, therefore, the process costs increase.

### Comparative Example 3

40 g of Fe(NO₃)₃ was dissolved in 200 ml of water, and ammonia water diluted at a ratio of 1:1 was slowly added to this aqueous solution to adjust the pH of the solution to 5 to 7. Herein, approximately 150 ml of precipitate slurry was produced. 100 ml of butanol was added thereto, and mixed with the slurry at high speed of 3000 rpm. After filtering the result, the filtered result was dried for 3 hours or longer at 130° C. using an oven-type drying apparatus. Herein, the dried iron hydroxide exhibited apparent specific gravity of 3.56, and a specific surface area of 3.8 m²/g.

Meanwhile, when propanol is used, the propanol is not readily separated from the water due to its high solubility for water, and a complex separate process is required for separation, therefore, the process is inefficient and costly.

### Comparative Example 4

20 g of Fe(NO₃)₃ was dissolved in 200 ml of water, and ammonia water diluted at a ratio of 1:1 was slowly added to this aqueous solution to adjust the pH of the solution to 5 to 7. Herein, Fe(OH)₃ precipitates were produced. After filtering the result, 300 ml of propanol was added to the filtered precipitate slurry. When the result was mixed at 3000 rpm using a high speed mixer, the water component in the precipitate slurry was completely mixed with the propanol.

The result was filtered, and 300 ml of new propanol was added thereto to be mixed with the filtered slurry at high speed. This process was repeated 5 times and the result was filtered. However, collecting and filtering were not simple since there was no layer separation when propanol was mixed as a solvent. After the reaction was complete, the iron hydroxide was dried at 130° C. The dried iron hydroxide product exhibited apparent specific gravity of 1.79, and a specific surface area of 58 m²/g.

While the present disclosure has been shown and described in connection with the embodiments, it will be apparent to those skilled in the art that modifications and variations can be made without departing from the scope of the invention as defined by the appended claims.

1. A method for producing a porous metal oxide powder comprising:
obtaining metal oxide precipitate slurry from an aqueous metal salt solution dissolving a water-soluble metal salt in water;
solvent exchanging the water by mixing a butanol solvent and the metal oxide precipitate slurry; and
drying the solvent exchanged metal oxide under atmospheric pressure conditions.

2. The method for producing a porous metal oxide powder of claim 1, wherein the operation of obtaining the metal oxide precipitate slurry is carried out by adjusting a pH of the aqueous metal salt solution.

3. The method for producing a porous metal oxide powder of claim 1, wherein the water-soluble metal salt is selected from the group consisting of Fe(NO₃)₃, Fe(OH)₃, ammonium paratungstate (APT), Na₂ WO₄, Na₂Mo₄, Al(NO₃), Al(NO₃)₃, Al₂(SO₄)₃, Zn(NO₃)₂, Ni(NO₃)₂, Fe(NO₃)₃, Cu(NO₃)₂, CdCl₂, ZrCl₄, TiCl₄ and MgSO₄.

4. The method for producing a porous metal oxide powder of claim 1, wherein the butanol solvent is added in an amount of 50 to 99% by weight based on the total weight of the butanol solvent and the metal oxide precipitate slurry.

5. The method for producing a porous metal oxide powder of claim 1, further comprising removing a by-product by calcination at a temperature of 150° C. to 300° C. subsequently to the operation of drying.

6. The method for producing a porous metal oxide powder of claim 1, further comprising removing a by-product by washing the metal oxide precipitate slurry with water subsequent to the operation of obtaining the precipitate slurry.

7. The method for producing a porous metal oxide powder of claim 1, wherein the operation of solvent exchanging is carried out using a forced mixing method accompanying stirring conducted at a speed of 1000 to 40000 rpm.

8. The method for producing a porous metal oxide powder of claim 1, wherein the operation of solvent exchanging is carried out by repeating an operation of adding and mixing a new solvent with the metal oxide precipitate slurry, and then separating the obtained water-saturated butanol 2 to 6 times.

9. The method for producing a porous metal oxide powder of claim 1, wherein the operation of solvent exchanging is carried out by reflux at a temperature of 100 to 130° C.

10. The method for producing a porous metal oxide powder of claim 1, wherein the operation of solvent exchanging is carried out using a solvent additionally including a hydrophobizing agent.

11. The method for producing a porous metal oxide powder of claim 10, wherein the hydrophobizing agent is selected from among hexamethyldisilane (HMDS), trimethylenemethane (TMMS), ethyltriethoxysilane (ETES) and hexamethyldisiloxane (HMDSO).

12. The method for producing a porous metal oxide powder of claim 1, further comprising filtering the metal hydroxide precipitate slurry before, after, or both before and after the operation of solvent exchanging.

13. The method for producing a porous metal oxide powder of claim 1, further comprising reproducing butanol by mixing the water-saturated butanol obtained in the operation of solvent exchanging with at least one of anhydrous calcium chloride (CaCl2), phosphorous pentoxide (P₂ O₅), and anhydrite (CaSO₄), and then phase separating the water.
